(19) United States
(12) Patent Application Publication
(10) Pub. No.: US 2021/0283816 A1
(43) Pub. Date: Sep. 16, 2021

(54) CYLINDER FOR A PLASTICS-PROCESSING MACHINE AND METHOD FOR OPERATING AN EXTRUDER

(71) Applicant: KRAUSSMAFFEI TECHNOLOGIES GMBH, München (DE)

(72) Inventors: Hans-Peter Schneider, München (DE); Robert Breitenberger, Wilzhofen (DE); Walter Breuning, Bergkirchen (DE)

(21) Appl. No.: 16/338,787

(22) PCT Filed: Sep. 14, 2017
(86) PCT No.: PCT/EP2017/073103

§ 371 Date: Apr. 2, 2019

(30) Foreign Application Priority Data
Oct. 18, 2016 (DE) 10 2016 119 858.7

(51) Int. Cl. B29C 48/68; B29C 48/40

(52) U.S. Cl. CPC B29C 48/6803; B29C 48/402

(57) ABSTRACT

A cylinder for a plastics-processing machine is provided, comprising at least two hollow-cylindrical bodies. At least one portion of at least one hollow-cylindrical body is provided with an inner coating, particularly a wear-protection layer, and can be attached to the other hollow-cylindrical body, the one hollow-cylindrical body being attachable to the other hollow-cylindrical body in a plurality of different positions. A device is further provided for processing a material and a method is also provided for operating an extruder.

The invention relates to a cylinder, in particular a plasticizing cylinder, for a plastics-processing machine. The invention further relates to a device for processing a material, for example plastic, rubber or suchlike, with a multi-screw extruder, in particular a double screw extruder, wherein the extruder has at least two screws for the processing of the material, wherein the screws are mounted rotatably in a cylinder and are able to be driven by means of at least one drive. In addition, the invention relates to a method for operating an extruder.

Devices for the processing of a material with an extruder have been known in practice for a long time. Such extruders are used for the processing of material, for example for the plasticizing or melting of plastic or rubber, but also in the food industry. In particular, double- or multi-screw extruders are particularly well suited in the melting or respectively plasticizing of material. The screws are mounted so as to be rotatable in the same direction or in the opposite direction in a housing or respectively cylinder, wherein the screws are able to be driven by means of a drive. The rotation direction of the screws is predetermined here by the course of the screw flights and the discharge direction of the material which is to be processed.

For particular applications, for example for the industrial manufacture of semi-finished products, such as hard PVC dry blend, etc., multi-screw extruders such as for instance double screw extruders are frequently used, because the requirements which are set here for the extruders are met particularly well by these machines. For example, a good constant material feed, a gentle material preparation and a high capability for pressure build-up are to be emphasized. For such method tasks in practice counter-rotating, meshing (e.g. closely meshing) double-screw extruders are frequently preferred. A further advantage of the counter-rotating double-screw extruders is the self-cleaning, which results through the positively controlled conveying. Other devices, such as for example double-screw extruders rotating in the same direction, cascade extruders and planetary-gear extruders or suchlike are likewise advantageous for similar or other method tasks.

Owing to the rotation of the screws and the filling of the cylinder and the processing of the material, generally forces occur during the operation of an extruder which bring the screw in contact with the cylinder/housing. In the case of a counter-rotating, closely meshing double-screw extruder, for example, resulting forces occur which press the screws in the region of an angle plane of approximately 45° to the axial plane of the double screw against the cylinder inner wall. Through the solid body/solid body contact of the screw outer circumference and the cylinder inner wall, in addition to the adhesive wear also abrasive wear occurs through the processing of fillers (for example chalk). The adhesive wear forms the main part of the wear on the cylinder and on the screws in multi-screw extruders. With increasing service life of the extruder, owing to the continuously acting forces (and the decreasing nitriding hardness in nitrided cylinders) in particular the wear on the cylinder inner wall increases.

Various possibilities now exist in order to minimize the wear on the housing/cylinder and the screws. For example, DE 39 35 970 A1 discloses an extruder with an extrusion cylinder which consists of a steel jacket and bushes of hard metal or of comparable materials inserted therein. When adhesive wear now occurs, these bushes are simply exchanged.

EP 1 336 465 A1 describes another possibility, in which the inner wall of the plasticizing cylinder is provided with a wear-protection layer, wherein axially-running grooves are formed in the inner coating.

In the case of high-performance extruders, the cylinders are exposed to high stresses, whereby, despite wear-reducing measures such as are described for instance in the prior art, a considerably shortening of the service life of the cylinder and of the device occurs. A further disadvantage is that the extruder housing can be provided, if at all, only with a specific wear-protection layer. However, different protection layers are necessary for different types of wear. Finally, housings which are damaged by wear must generally be exchanged for a new housing. In the case of wear, therefore, the entire component always has to be changed. This exchange involves high investment costs.

The present invention is therefore based on the problem of indicating a cylinder for a plastics-processing machine and a device for processing a material of the type named in the introduction and a method for operating an extruder, according to which as favourably priced an extension as possible of the service life of the cylinder and therefore of the device is made possible.

According to the invention, the above problem is solved by a cylinder for a plastics-processing machine having the features of claim 1. Accordingly, the cylinder has at least two hollow-cylindrical bodies, wherein at least one portion of at least one hollow-cylindrical body is provided with an inner coating, particularly a wear-protection layer, and can be attached to the other hollow-cylindrical body, the one hollow-cylindrical body being attachable to the other hollow-cylindrical body in a plurality of different positions. The cylinder or respectively extruder cylinder can therefore be constructed having several parts. The cylinder can have several cylinder segments in the form of hollow-cylindrical bodies. According to a preferred variant, the cylinder can be constructed having two parts. The cylinder can therefore have a first hollow-cylindrical body and a second hollow-cylindrical body. The first hollow-cylindrical body can be separated from the hollow-cylindrical body. The cylinder can alternatively also have more than two, for example three, four, five or six hollow-cylindrical bodies.

In a manner according to the invention it has therefore been recognized that in a departure from the practice hitherto, the service life of the housing can be increased not solely through measures of wear protection on the screws or on the housing, but rather that an increase of the service life can take place in that the cylinder is worn at different regions. This is achieved from a technical point of view in a particularly simple and ingenious manner in that the cylinder is configured having several parts, preferably two parts, and at least one of the hollow-cylindrical bodies resulting therefrom is provided with a wear-protection layer at least in one portion.

In the case of wear, the one hollow-cylindrical body can be easily dismantled and attached in a different position, in such a way that a site on the inner wall of the hollow-cylindrical body which is not, or is scarcely affected by wear, advances to the position of an intensively wearing site. Kinematically, the wear is generally always brought about in the upper region of the cylinder segment. Through the diverting of the hollow-cylindrical body in changing different positions, a higher, e.g. double, wear volume arises and thereby a longer duration of use. Therefore, wear does indeed occur, but this wear occurring in other regions of the cylindrical body makes it possible to distinctly increase the service life of the cylinder, partly to more than double it. In addition, an individual adaptation of the selected wear-protection layer to the respective requirement of the cylinder zone is made possible. The cylinder can therefore be used again with its site(s) which is/are not or are scarcely worn. Thereby, the duration of use is extended and the service life of the machine is increased significantly. Likewise, no further investment costs are incurred, e.g. for a new cylinder or a housing.

The hollow-cylindrical body of the cylinder, provided with the inner coating, can be fastened or mounted in several positions, for example two, on the other hollow-cylindrical body of the cylinder. The one hollow-cylindrical body can be attachable to the other hollow-cylindrical body relative to an original position in a position rotated through 180°, 120°, 90° or 45°. The original position is the position of the hollow-cylindrical body in which the latter was attached for the first or previous time to the other hollow-cylindrical body. Alternatively or additionally, the hollow-cylindrical body can be configured to be rotatable/revolvable by any desired angle and/or defined angle according to the configuration of the cylinder and/or of an extruder about an axis (e.g. longitudinal axis) of the cylinder.

The one hollow-cylindrical body can be attached to the other hollow-cylindrical body in a detachable manner. For example, the hollow-cylindrical bodies can be screwed to one another.

The hollow-cylindrical bodies can have respectively at least two longitudinal bores parallel to one another, which overlap one another with the formation of a spectacle bore. Alternatively or additionally, hollow-cylindrical bodies can have three, four, five or more longitudinal bores parallel to one another. The hollow-cylindrical bodies can thus be attached to one another so that the longitudinal axes of their bores are congruent to one another. The cylinder can thus have two or more longitudinal bores which are parallel to one another.

The inner coating can be formed substantially in the interstice region of the spectacle bore. Alternatively or additionally, the inner coating can be formed in a region of an angle plane of approximately 45° to an axial plane of the hollow-cylindrical body or cylinder. Alternatively, the inner coating can extend over the entire inner surface of the hollow-cylindrical body. The hollow-cylindrical body can have one or more inner coatings. The inner coatings can be arranged in portions on the hollow-cylindrical body.

According to a variant, the other hollow-cylindrical body can be provided at least in one portion with an inner coating, in particular a wear-protection layer. Also, all the hollow-cylindrical bodies of the cylinder can be provided, at least in one portion, with an inner coating. Preferably, however, only the hollow-cylindrical bodies of the cylinder which are arranged in zones of the greatest wear are provided with an inner coating.

The inner coating of the one hollow-cylindrical body can be different from the inner coating of the other hollow-cylindrical body or the other hollow-cylindrical bodies. It is also conceivable that selected hollow-cylindrical bodies have wear-protection layers which are different from one another. Through the separable configuration of the cylinder, different wear-protection layers can be realized in the respective zones of the hollow-cylindrical bodies. In a variant, the inner wall of a hollow-cylindrical body can have different inner coatings. This has the advantage that the wear-protection layers can be adapted to the respective requirements and different wear conditions.

The inner coating or respectively wear-protection layer can have an alloy, preferably a metal alloy, ceramic and/or bimetal, preferably tungsten carbide or any desired combination thereof. Additionally or alternatively, the inner coating can be produced by hardening, for example inductive hardening.

According to a further aspect, a device is indicated for processing a material, for example plastic, rubber or suchlike, with a multi-screw extruder, in particular a double-screw extruder, wherein the extruder has at least two screws for processing the material, wherein the screws are mounted rotatably in a cylinder as described above and/or in the following, and are able to driven by means of at least one drive.

The screw(s) can have, at least in one portion, an outer coating, in particular a wear-protection layer. The outer coating on the screw(s) can be provided in the region of the inner coating of the cylinder or respectively of the hollow-cylindrical body. This means that the outer coating can be provided on the screw(s) in the region at which, opposite the screw, the region of the inner coating of the cylinder or respectively hollow-cylindrical body is provided. The screw(s) can also have an outer coating, which extends over the portion of the screw which is situated within the hollow-cylindrical body, in particular the hollow-cylindrical body with an inner coating. Alternatively, the outer coating can also extend over the entire length of the screw. The screw(s) can have one or more outer coatings. In a variant, the outer coating can be configured as a suitable or corresponding wear-protection layer to the inner coating of the cylinder. The outer coating of the screw(s) can have an alloy, preferably a metal alloy, ceramic, molybdenum and/or bimetal, preferably tungsten carbide, or any desired combination thereof. In a variant, the screw(s) can have one or more outer coatings. For example, the screw(s) can have two outer coatings. These two outer coatings can be, for example, molybdenum and tungsten carbide.

The multi-screw extruder can be configured as an extruder rotating in the opposite direction or in the same direction. The drive can comprise a motor which is able to be operated in two rotation directions.

During operation of the multi-screw extruder, the forces resulting due to the rotation of the screws and the material filling of the extruder bring about wear on the cylinder inner wall. If the position of at least one hollow-cylindrical body of the cylinder is now changed, the later is therefore attached again at a different position on the other hollow-cylindrical body of the cylinder, the wear occurs at different regions of the hollow-cylindrical body. In these regions, after previous operation, again the maximum or at least predominantly wear-protection layer is present, so that the cylinder can be used for a considerably increased service life. In addition, the changed forces lead if applicable also to a changed wear on the screws, so that, in some circumstances, the run time of the screws can also be extended.

In a particularly preferred configuration for the processing of specific materials, the extruder could be configured as a double-screw extruder, rotating in the same direction or respectively in the opposite direction, with a meshing, preferably closely meshing, screw profile. However, any other type of extruder, for example single-screw extruder, cascade- or planetary gear extruder or suchlike could also be conceivable. The choice of the suitable extruder depends here on the method task which is set. The screws could, for example, be configured as parallel screws or as conical screws.

According to a further aspect, a method is indicated for operating an extruder with at least two screws. The method according to the invention could serve in particular for operating a device according to the above and/or following embodiments, wherein a hollow-cylindrical body of the cylinder is attached in a different position relative to its original position. In the method, it is advantageous that through the possibility of the later different attaching of the hollow-cylindrical body of the cylinder to the other hollow-cylindrical body of the cylinder, the service life of the cylinder can be increased significantly.

The processing of the material is stopped according to the type of the extruder and/or of the processed material. This operating point can be selected differently according to the method task. For example, the operating point could be selected so that the occurring wear is still so small that it does not lead to any substantial damage to the cylinder, to the screws and/or to the product in the wear region. In an advantageous manner, however, the operating point could also be selected such that the wear and the damage resulting therefrom lead to the product being unusable. The operating duration could therefore be in accordance with the type of housing and/or of the processed material. The operating duration could be selected according to the wear of the cylinder inner wall and/or of the screws and/or the sensitivity of the material and/or product. The operating point at which the production is stopped could therefore be partly calculated for materials which are to be processed or determined from empirical values. The operating point could, however, be determined at least from the quality of the extruded product.

Various possibilities now exist for configuring and further developing the teaching of the present invention in an advantageous manner. For this, on the one hand, reference is to be made to the claims and on the other hand to the following explanation of a preferred example embodiment of the cylinder according to the invention for a plastics-processing machine and of the device for processing a material, with the aid of the drawings. In connection with the explanation of the preferred example embodiment of the cylinder according to the invention, the device and the method according to the invention for operating an extruder, with the aid of the drawings, also in general preferred configurations and further developments of the teaching are explained. Further aspects, features and advantages of the cylinder disclosed here and device will also emerge from the example embodiments explained below and from the figures. There are shown:

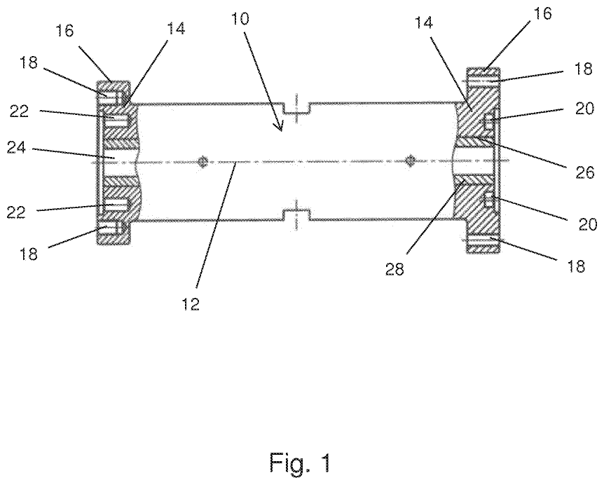

FIG. 1 in a side view, partly in section, an example embodiment of a hollow-cylindrical body with an inner coating;

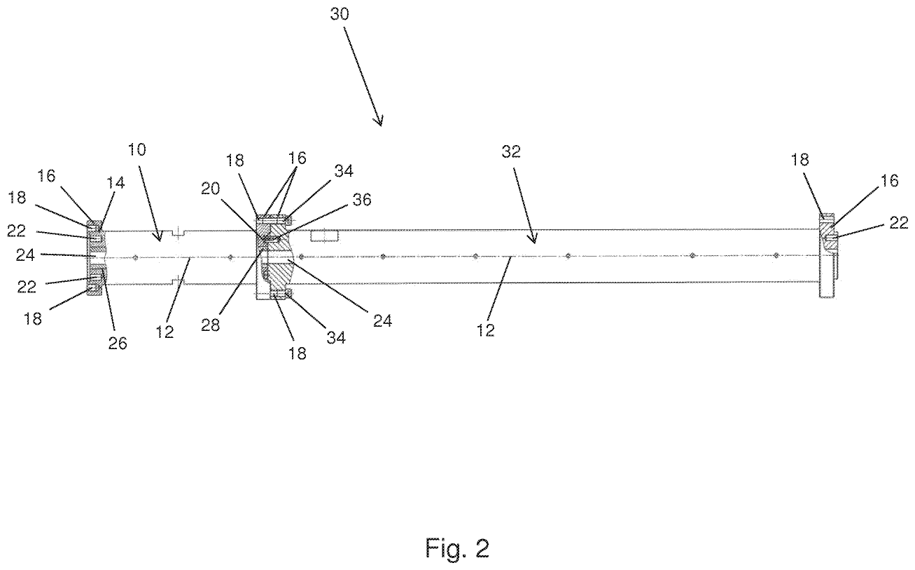

FIG. 2 in a side view, partly in section, an example embodiment of a cylinder, divided in two, with the hollow-cylindrical body according to FIG. 1 and with a further hollow-cylindrical body;

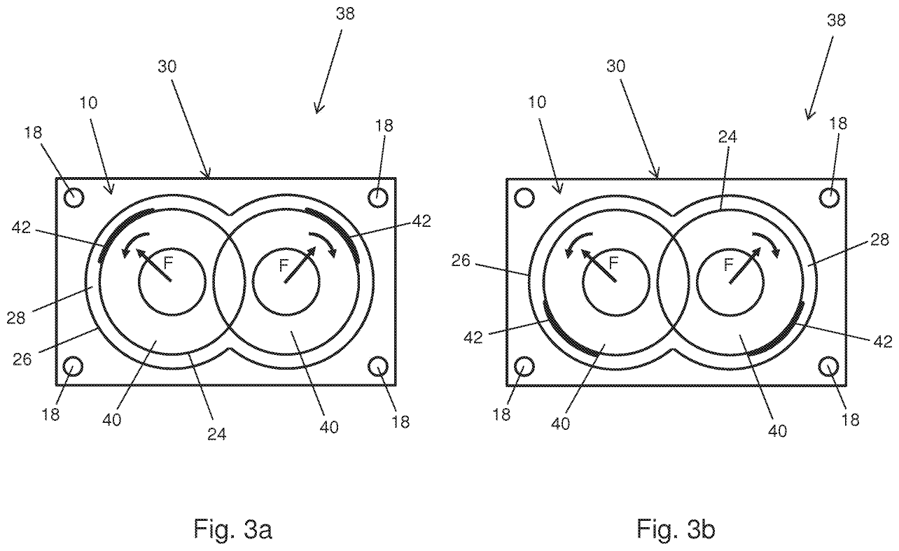

FIG. 3a in a diagrammatic illustration in section, an example embodiment of a device for processing a material with the cylinder according to FIG. 2; and

FIG. 3b in a diagrammatic illustration in section, the device for processing a material according to FIG. 3a, wherein the hollow-cylindrical body according to FIG. 1 was attached at a different position.

In the following, the example embodiments are explained by way of example. Conforming or comparable elements are given the same reference numbers.

In FIG. 1 an example embodiment of a hollow-cylindrical body 10 is illustrated in a side view, partly in section. The hollow-cylindrical body 10 has a longitudinal axis 12. The longitudinal axis 12 constitutes a rotation axis of the hollow-cylindrical body 10. The longitudinal axis 12 extends in the method direction of the hollow-cylindrical body 19. Along its longitudinal axis, the hollow-cylindrical body 10 has two ends 14. The ends 14 of the hollow-cylindrical body 10 thus form opposite lateral faces.

At each end 14 the hollow-cylindrical body 12 has a projection 16 extending substantially in perpendicular direction to the longitudinal axis 12 of the hollow-cylindrical body 10. In the present example embodiment, the projection 16 is configured as a flange 16. The flange 16 is formed in one piece with the hollow-cylindrical body 10 and therefore forms a flange portion 16 of the hollow-cylindrical body 10. The flange portion 16 can have a round cross-section, but preferably, as in the present example embodiment, can also have a rectangular cross-section. The cross-section of the flange 16 extends in a plane which runs substantially perpendicularly or transversely to the longitudinal axis 12 of the hollow-cylindrical body 10. The cross-sections of the two flange portions can be identical or, as in the present example embodiment, can have a cross-sectional area of different size. The flange portion or respectively flange 16 has one or more bores 18. The bores 18 can be embodied as through-bores or blind bores. The bores 18 of the flange 16 can, as in the present example embodiment, have an internal thread. The bores 18 can therefore be configured as threaded bores 18. By means of these threaded bores 18, the hollow-cylindrical body 10 can be attached to another hollow-cylindrical body and can preferably be screwed to the latter by means of bolts or pins (shown in FIG. 2). In addition, the flange portion 16 can have openings 20, for example in the shape of a hexagon. Other shapes, such as for instance triangle, rectangle and round are also conceivable. The openings 20 can also be configured as a bore. The openings 20 can be arranged only on one of the two flange portions 16 (on the right-hand flange portion in FIG. 1) or on both flange portions 16 (not shown in FIG. 1). Furthermore, the flange portions 16 can have, additionally or alternatively, bores 22, preferably blind bores 22. These blind bores 22 can likewise be arranged only on one of the two flange portions 16 (on the left-hand flange portion in FIG. 1) or on both flange portions 16 (not shown in FIG. 1). The two flange portions 16 can therefore be configured similarly or identically. The bores 18, openings 20 and/or the blind bores 22 extend substantially in a direction parallel to the longitudinal axis 12 of the hollow-cylindrical body 10.

The hollow-cylindrical body 10 has two longitudinal bores 24 parallel to one another, which extend substantially in the direction of the longitudinal axis 12 of the hollow-cylindrical body 10. In the present example embodiment, the longitudinal bores 24 overlap one another and form a spectacle bore 24 (illustrated diagrammatically in FIGS. 3a and 3b). The spectacle bore defines an inner surface 26 of the hollow-cylindrical body 10. Alternatively, the hollow-cylindrical body 10, depending on the application, can have only one longitudinal bore 24 or several, for example three, four or five longitudinal bores 24, wherein in the latter case the longitudinal bores 24 can overlap one another at least in pairs.

As shown in FIG. 1, the hollow-cylindrical body 10 has, at least in one portion, an inner coating 28. In the present example embodiment, the inner coating 28 is formed over the entire inner surface 26 of the hollow-cylindrical body 10. Alternatively, the inner coating 28 can be formed only in portions on the inner surface 26 of the hollow-cylindrical body 10. For example, the inner coating 28 is formed substantially in the interstice region of the spectacle bore 24 of the hollow-cylindrical body 10. The inner coating 28 is, in particular, a wear-protection layer 28. The wear-protection layer 28 is preferably made from a wear-inhibiting material. The wear-protection layer 28 can have for example an alloy, preferably a metal alloy, ceramic, and/or bimetal, preferably tungsten carbide, or a combination thereof. Alternatively or additionally, the wear-protection layer 28 can be produced by hardening, for example inductive hardening. In the present example embodiment, the wear-protection layer 28 is formed from tungsten carbide.

FIG. 2 shows now in a side view, partly in section, an example embodiment of a cylinder 30, divided in two, with the hollow-cylindrical body 10 according to FIG. 1 and with a further hollow-cylindrical body 32. However, several, e.g. three, four, five, etc. hollow-cylindrical bodies 10 and/or hollow-cylindrical bodies 32 can also form a cylinder 20.

The hollow-cylindrical body 32 corresponds substantially to the hollow-cylindrical body 10. The hollow-cylindrical body 32 therefore has substantially the features described with reference to the hollow-cylindrical body 10 and shown in FIG. 1. A difference between the hollow-cylindrical body 32 and the hollow-cylindrical body 10 lies, however, in that in the present example embodiment the hollow-cylindrical body 32 has no inner coating 28. Alternatively, the hollow-cylindrical body 32 can have at least in one portion an inner coating 28, preferably on the inner surface 26 of its longitudinal bore(s) 24. In a variant, the hollow-cylindrical body 32 can have on its entire inner surface 26 an inner coating in the form of a wear-protection layer 28. The inner coating 28 of the hollow-cylindrical body 10 can be different from the inner coating 28 of the hollow-cylindrical body 32. The inner coating 28 can therefore be adapted to the respective method zone of the cylinder 30. Alternatively, however, the inner coating 28 can be embodied identically in the hollow cylindrical body 10, 32.

The hollow-cylindrical body 10 is attached to the other hollow-cylindrical body 32, wherein the hollow-cylindrical body 10 is attachable to the other hollow-cylindrical body 32 in several different positions. For this purpose, in the present example embodiment, the hollow-cylindrical body 10 is attached to the other hollow-cylindrical body 32 in a detachable manner. As shown in FIG. 2, the two hollow-cylindrical bodies 10 and 32 are screwed to one another by means of bolts 34. Alternatively or additionally, the hollow-cylindrical bodies 10, 32 can be connected to one another by means of pins, threaded rods, lock screws, etc. In FIG. 2 this is illustrated by way of example by threaded pins 36. The hollow-cylindrical bodies 10, 32 are attached to one another by means of their flange portions 16. Here, they are connected to one another so that the spectacle bore 24 of the hollow-cylindrical body 10 with the spectacle bore 24 of the hollow-cylindrical body 32 are aligned congruently in longitudinal direction along the longitudinal axis 12. The longitudinal axes of the spectacle bores 24 are therefore formed congruently to one another.

As shown in FIG. 2, owing to the divided configuration of the cylinder 30, the hollow-cylindrical body 10 can be dismantled again. In particular in the case of wear, the hollow-cylindrical body 10 can be detached from the hollow-cylindrical body 32 again by means of the bolts and pins 36. The hollow-cylindrical body 10 is therefore able to be attached to the other hollow-cylindrical body 32 in a position rotated through for example 180°, 120°, 90° or 45° relative to its original position (i.e. to its originally mounted position). The hollow-cylindrical body 10 can be rotated about its longitudinal axis 12 and subsequently attached to the other hollow-cylindrical body 32 again. Alternatively or additionally, the hollow-cylindrical body 10 can also be rotated about an axis perpendicular to the longitudinal axis 12. This perpendicular axis preferably lies in the horizontal plane of the hollow-cylindrical body 10. A rotation of the hollow-cylindrical body 10 through 180° about the longitudinal axis 12 and/or about the axis of the hollow-cylindrical body 10 perpendicular to the longitudinal axis 12 is preferred. Alternatively or additionally, the hollow-cylindrical body can be configured to be rotatable/revolvable about an axis of the cylinder 30 by any and/or required angle depending on the configuration of the cylinder 30 and/or of an extruder. The hollow-cylindrical body 10 can therefore be mounted in two or more positions on another hollow-cylindrical body.

In FIGS. 3a and 3b an example embodiment is illustrated, in a diagrammatic illustration in section, of a device 38 for processing a material, in this case plastic, with the cylinder 30 according to FIG. 2. The device comprises an extruder, wherein the extruder is configured as a multi-screw extruder. In the present example embodiment, the extruder is a double-screw extruder. The extruder has two screws 40 for the plasticizing of plastic. The screws are mounted rotatably in the cylinder 30. As can be seen in FIGS. 3a and 3b, the screws are mounted in the spectacle bore 24 of the cylinder 30.

The screws 40 can have at least in one portion an outer coating, in particular a wear-protection layer. The outer coating on the screws 40 can be provided in the region of the inner coating 28 of the cylinder 30 or respectively of the hollow-cylindrical body 10. This means that the outer coating can be provided on the screws 40 in the region at which the region of the inner coating 28 of the cylinder 30 or respectively of the hollow-cylindrical body 10 is provided opposite the screw 40. In a variant, the outer coating can be configured as a suitable or corresponding wear-protection layer to the inner coating 28 of the cylinder 30. The outer coating of the screws 40 can have an alloy, preferably metal alloy, ceramic, molybdenum and/or bimetal, preferably tungsten carbide or any combination thereof. In a variant, the screws 40 can have one or more outer coatings. For example, the screws can have two outer coatings. These two outer coatings can be, for example, molybdenum and tungsten carbide. In the present example embodiment, the screws 40 have an outer coating which extends over the portion of the screw which is situated within the hollow-cylindrical body 10, wherein the outer coating is configured as a suitable wear-protection layer with respect the inner coating 28 of the hollow-cylindrical body 10 and has tungsten carbide.

The screws 40 are drivable by means of a drive which is not illustrated. The drive comprises a motor which is operable in two rotation directions. In addition, the drive can comprise a gear and/or transmission elements in the form of coupling elements. The extruder can be configured as an extruder rotating in the same direction or in the opposite direction. In the present example embodiment, the extruder is configured as a meshing (here closely meshing) double-screw extruder rotating in the opposite direction (indicated by the arrows in FIGS. 3a and 3b). The drive drives the first screw 40 (the left-hand screw in FIGS. 3a and 3b) anti-clockwise, and the second screw 40 (the right-hand screw in FIGS. 3a and 3b) clockwise. However, a converse rotation direction of the screws is also conceivable.

In FIG. 3a the rotation direction of the individual screws 40 and the acting contact pressure forces F are shown. In operation, the screws 40 act on the cylinder and therefore on the hollow-cylindrical body 10. Wear occurs in particular on the hollow-cylindrical body 10 in the region of approximately 9.00 to 11.00 hrs and 13.00 to 15.00 hrs; illustrated diagrammatically by the thickened circular arcs 42. The cylinder wear occurs, as shown in FIG. 3a, on the wear-protection layer 28. Therefore, the hollow-cylindrical body 10 is not damaged directly. Depending on the plastics material which is processed, the processing is stopped after a particular operating duration, at which the occurring cylinder wear 42 is still so small that it still does not lead to any substantial damage to the product, the cylinder 30 and/or the screws 40. This is usually the case when only the wear-protection layer 28 of the hollow-cylindrical body 10 is affected by wear. When this operating point is reached, the hollow-cylindrical body 10 of the extruder cylinder 30 is attached in a different position relative to its original position. In the present example embodiment, the hollow-cylindrical body 10 is firstly detached from the hollow-cylindrical body 32 by means of the bolts 34. The hollow-cylindrical body 10 is then rotated through 180° about its longitudinal axis 12. Thus the hollow-cylindrical body 10 is attached or respectively screwed in this position onto the hollow-cylindrical body 32 again. The hollow-cylindrical body 10 was therefore attached to the other hollow-cylindrical body 32 from its original position (as shown in FIG. 3a) in a different position (here rotated through 180°) (as shown in FIG. 3b).

FIG. 3b now shows the hollow-cylindrical body 10 in a position, rotated through 180° about the longitudinal axis 12 and screwed on the other hollow-cylindrical body 32 again. The cylinder wear 42 which is present therefore now lies in the region of approximately 7.00 to 9.00 hrs and 15.00 to 17.00 hrs. When the processing of plastics material is now started again, the cylinder wear now takes place on the wear-protection layer 28 which is not wearing or is scarcely affected, in the upper region of the hollow-cylindrical body 10 or respectively again for instance in the 9.00 hrs to 11.00 hrs and 13.00 to 15.00 hrs region.

With regard to further details, to avoid repetitions, reference is to be made to the general description.

Finally, it is to be expressly pointed out that the example embodiment or respectively example embodiments described above serves only for the explanation of the claimed teaching, but does not restrict this to the example embodiment.

### REFERENCE LIST

10 hollow-cylindrical body with coating
12 longitudinal axis
14 end
16 flange portion
18 threaded bores
20 openings
22 blind bores
24 longitudinal bores/spectacle bore
26 inner surface
28 inner coating/wear-protection layer
30 cylinder
32 hollow-cylindrical body without coating
34 bolts
36 threaded pins
38 device/extruder
40 screw(s)
42 cylinder wear
F contact pressure forces

What is claimed is:

1. A cylinder (30) for a plastics-processing machine (38),
comprising at least two hollow-cylindrical bodies (10, 32), wherein at least one portion of at least one hollow-cylindrical body (10) is provided with an inner coating (28) comprising a wear-protection layer (28), and can be attached to the other hollow-cylindrical body (32), the one hollow-cylindrical body (10) being attachable to the other hollow-cylindrical body (32) in a plurality of different positions.

2. The cylinder (30) according to claim 1,
wherein the one hollow-cylindrical body (10) is attachable to the other hollow-cylindrical body (32) in a position rotated through 180°, 120°, 90° or 45° relative to an original position.

3. The cylinder (30) according to claim 1,
wherein the one hollow-cylindrical body (10) is attached to the other hollow-cylindrical body (32) in a detachable manner.

4. The cylinder (30) according to claim 1,
wherein the hollow-cylindrical bodies (10, 32) are screwed to one another.

5. The cylinder (30) according to claim 1,
wherein the hollow-cylindrical bodies (10, 32) have respectively at least two longitudinal bores (24) parallel to one another, which overlap one another forming a spectacle bore (24).

6. The cylinder (30) according to claim 5,
wherein the inner coating (28) is formed substantially in the interstice region of the spectacle bore (24).

7. The cylinder (30) according to claim 1,
wherein the inner coating (28) is formed over the entire inner surface (26) of the hollow-cylindrical body (10) or in a region of an angle plane of approximately 45° to an axial plane of the cylinder (10).

8. The cylinder (30) according to claim 1,
wherein the other hollow-cylindrical body (32) is provided at least in one portion with an inner coating (28) comprising a wear-protection layer (28).

9. The cylinder (30) according to claim 6,
wherein the inner coating (28) of the one hollow-cylindrical body (10) is different from the inner coatings (28) of the other hollow-cylindrical body (32).

10. The cylinder (30) according claim 1,
wherein the inner coating (28) has an alloy, comprising at least one of a metal alloy, ceramic and/or bimetal, or a combination thereof.

11. The cylinder (30) according to claim 1,
wherein the inner coating (28) is produced by inductive hardening.

12. A device (38) for processing a material, for example plastic, rubber or suchlike, with a multi-screw extruder (38), comprising a double-screw extruder (38), wherein the extruder (38) has at least two screws (40) for the processing of the material, wherein the screws (40) are mounted rotatably in a cylinder (30) according to claim 1 and are drivable by means of at least one drive.

13. The device (38) according to claim 12,
wherein the screws (40) at least in one portion have an outer coating, comprising a wear-protection layer.

14. The device (38) according to claim 13,
wherein the outer coating is provided on the screws (40) in the region of the inner coating of the cylinder (30) or respectively of the hollow cylindrical body (10), wherein the outer coating is formed as a wear-protection layer suited to the inner coating.

15. The device (38) according to claim 13,
wherein the outer coating of the screws (40) has an alloy, comprising at least one of a metal alloy, ceramic, molybdenum and/or bimetal, or a combination thereof.

16. The device (38) according to claim 12,
wherein the multi-screw extruder (38) is configured as an extruder (38) rotating in the opposite direction or in the same direction.

17. The device (38) according to claim 12,
wherein the drive comprises a motor which is operable in two rotation directions.

18. A method for operating an extruder (38), with at least two screws (40), comprising the device (38) according to claim 12, wherein the processing of the material is stopped and a hollow-cylindrical body (10) of the extruder cylinder (30) is attached in a different position relative to its original position.
